(19) United States
(12) Patent Application Publication
(10) Pub. No.: US 2014/0352989 A1
(43) Pub. Date: Dec. 4, 2014

(54) WEED REMOVING AND EJECTING APPARATUS

(71) Applicant: Weed Zinger, LLC, Pickerington, OH (US)

(72) Inventors: David A. Weaver, Alexandria, OH (US); Andres N. Pech, Reynoldsburg, OH (US)

(73) Assignee: Weed Zinger, LLC, Pickerington, OH (US)

(21) Appl. No.: 14/155,494

(22) Filed: Jan. 15, 2014

Related U.S. Application Data
(60) Provisional application No. 61/830,676, filed on Jun. 4, 2013.

(51) Int. Cl. A01B 1/18

(52) U.S. Cl. CPC A01B 1/18
USPC 172/1; 172/378

(57) ABSTRACT

A weed removal device having a handle and a frame through which a rod extends. The rod has a mechanical lock near one end that connects the rod mechanically to the frame, and a base portion near the opposite end. The base portion includes pins that extend into soil around the weed to grasp the weed, and a foot pedal on which the user rests his weight to drive portions of the device into the soil. A spring is compressed when the pins are driven into the soil and grasp the weed, and upon removal of the weed and a plug of soil the mechanical lock can release the spring to expand and thereby eject the weed and soil with force sufficient to propel the weed many feed into a receptacle.

### CROSS-REFERENCES TO RELATED APPLICATIONS

This application claims the benefit of U.S. Provisional Application No. 61/830,676 filed Jun. 4, 2013. U.S. Provisional Application No. 61/830,676 is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates to garden tools and more specifically to garden tools that extract a weed, including the root, from the soil and eject the weed from the tool.

Conventional garden tools extract weeds from lawns using serrated tines, spikes and levers that securely fasten to a handle. In most of these devices the weed and roots are removed by a lower portion that is spaced a significant distance from the operator's hands. The weed must typically be removed from the lower portion manually using a plunging mechanism or lever action. The force required to eject the weed from the base is excessive and often difficult to generate, particularly for those with limited dexterity or strength in their hands. There is a need to improve on the efficiency of the release mechanism of these devices.

### BRIEF SUMMARY OF THE INVENTION

The device and alternatives described herein provide an efficient means of removing weeds with roots from soil. The device has a mechanism that releases the weed from the tool with minimal effort. The present invention has all of the advantages of existing weed removing tools without the disadvantages.

The preferred device contemplates an improved weed extraction device having an elongated frame with a central bore through which a rod extends. A foot pedal is rigidly mounted to the frame and a handle extends from the frame for gripping by an operator.

Multiple pins are drivingly linked to the rod and extend away from the frame for inserting into soil surrounding a weed. The improvement comprises a spring that is drivingly linked to the rod and frame for compressing the spring when the rod is moved in a first direction relative to the frame. A lock limits movement of the rod relative to the frame in a second, opposite direction. A trigger is mounted adjacent the handle and is configured to unlock the lock upon movement of the trigger. Unlocking of the trigger allows the rod to move relative to the frame in the second direction under expansion of the compressed spring at speed sufficient to eject the weed from the device and project the weed a predetermined distance from the device. This avoids the need to stoop over to remove the weed from the device, and allows the user to project the weed a distance into a receptacle, waste pile or other location.

In a preferred embodiment of the invention, the weed extraction device lock further comprises a tab formed on the trigger, and a bias mounted to the trigger to bias the tab toward the rod. Multiple indentations are formed on the rod, and the tab can insert into an indentation for locking the rod against movement in the second direction. The trigger in a preferred embodiment is mounted beneath the handle when the device is in an operable orientation, such as when the device is substantially perpendicular to the surface in which the weed is growing. The trigger pivots about a pivot point on an opposite side of the frame from the handle, and the indentations on the rod are formed on a side of the rod facing away from the handle. The preferred foot pedal mounts rigidly to an end of the frame, directly below the handle, and has a pair of spaced sidewalls forming a gap therebetween. An anti-rotation guide extends toward the frame from attachment to a lower disk. The lower disk is mounted to the rod and the guide extends into the gap between the sidewalls of the pedal.

The invention also contemplates a method of using a weed extraction device having an elongated frame with a central bore through which a rod extends. A foot pedal is rigidly mounted to the frame and a handle extends from the frame so an operator can grasp the handle. Multiple pins are drivingly linked to the rod and extend away from the frame for inserting into soil surrounding a weed. The method comprises depressing the frame at the foot pedal downwardly toward the soil surrounding the weed. The step of depressing the frame thereby moves the rod in a first direction relative to the frame, which compresses a spring that is drivingly linked to the rod and the frame. The pins are thereby inserted into the soil around the weed and grasp the weed and at least some soil. Furthermore, a lock that limits movement of the rod relative to the frame in a second, opposite direction is locked. The method further comprises lifting the device by at least the handle, thereby removing at least the device and the weed from the soil. And, while grasping the device handle, the method includes the step of raising from the ground a lower end of the device that includes at least the pins. The method includes positioning the lower end of the device substantially between the user and a receptacle and grasping a trigger mounted adjacent the handle to unlock the lock. By grasping the trigger, the operator thereby causes the rod to move relative to the frame in the second direction under expansion of the compressed spring. This movement occurs at speed sufficient to eject the weed from the device and project the weed a predetermined distance from the device, for example into a trash container, compost heap or other receptacle.

### BRIEF DESCRIPTION OF THE SEVERAL VIEWS OF THE DRAWINGS

FIG. 1 is a view in perspective illustrating the preferred embodiment of the present invention.

FIG. 2 is a side view illustrating the preferred embodiment of the present invention with the handle and mechanism enlarged.

FIG. 3 is a top view in perspective illustrating the preferred embodiment of the present invention with the handle and mechanism enlarged.

FIG. 4 is a side view illustrating the preferred embodiment of the present invention with the base portion enlarged.

FIG. 5 is a view in perspective illustrating the preferred embodiment of the present invention with the base portion enlarged.

FIG. 6 is schematic side view in section illustrating the preferred embodiment with the mechanism in a first position for when the base portion engages the soil.

FIG. 7 is a schematic side view in section illustrating the preferred embodiment with the mechanism in a second position for when the mechanism has compressed the spring and grasped a weed.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

The above claimed priority application is hereby incorporated in this application by reference.

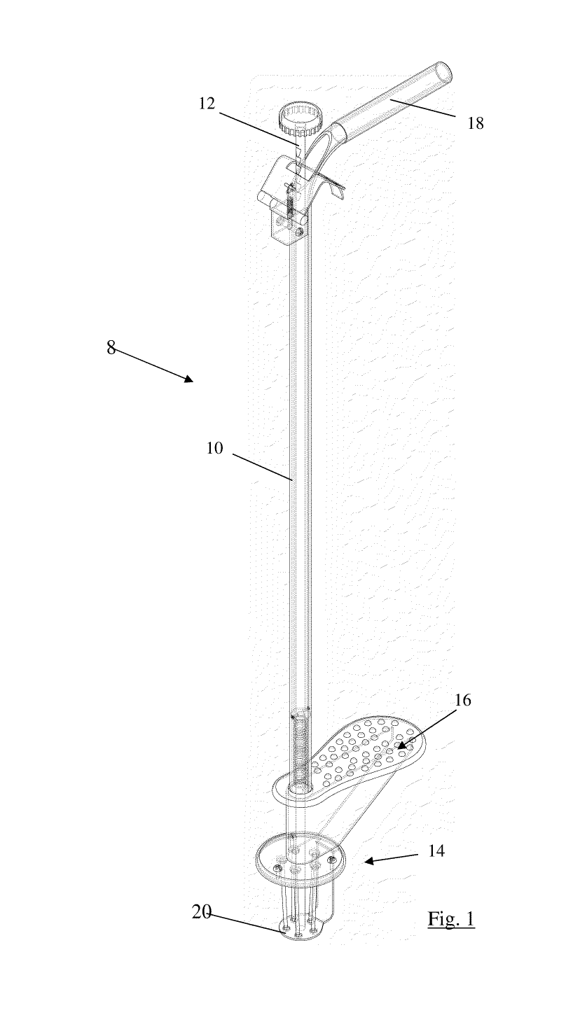

The device 8 shown in FIG. 1 is a manually-operated weed removal tool. A frame 10 has a central bore 11 formed through the center thereof, thereby defining the frame as a tubular body. The frame 10 is preferably circular in cross section, but can be rectangular, triangular, U-shaped or irregularly shaped. Unless described otherwise the frame 10 and all other components are made of steel. Of course, aluminum, plastic, fiber-reinforced polymer composite and other suitable materials can be substituted for steel, as will become apparent from the description herein to a person having ordinary skill.

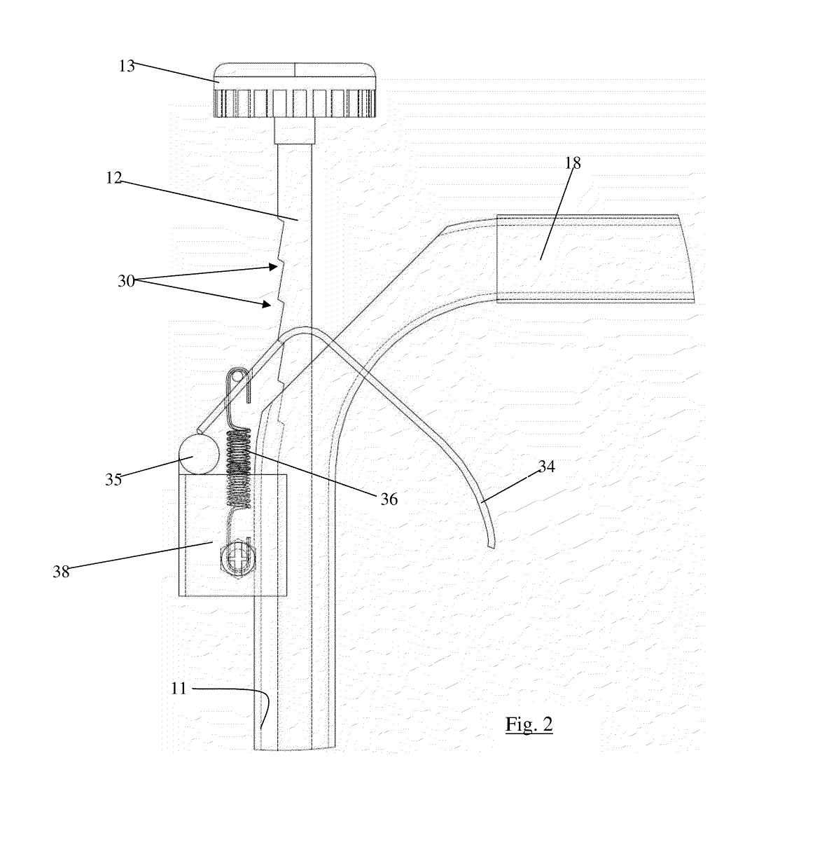

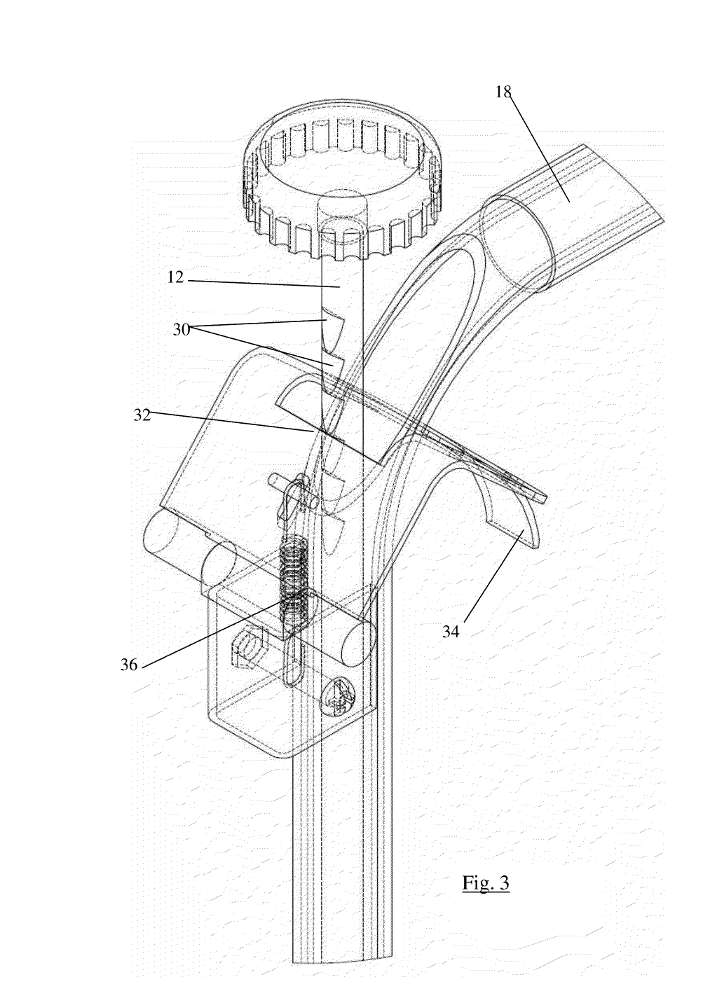

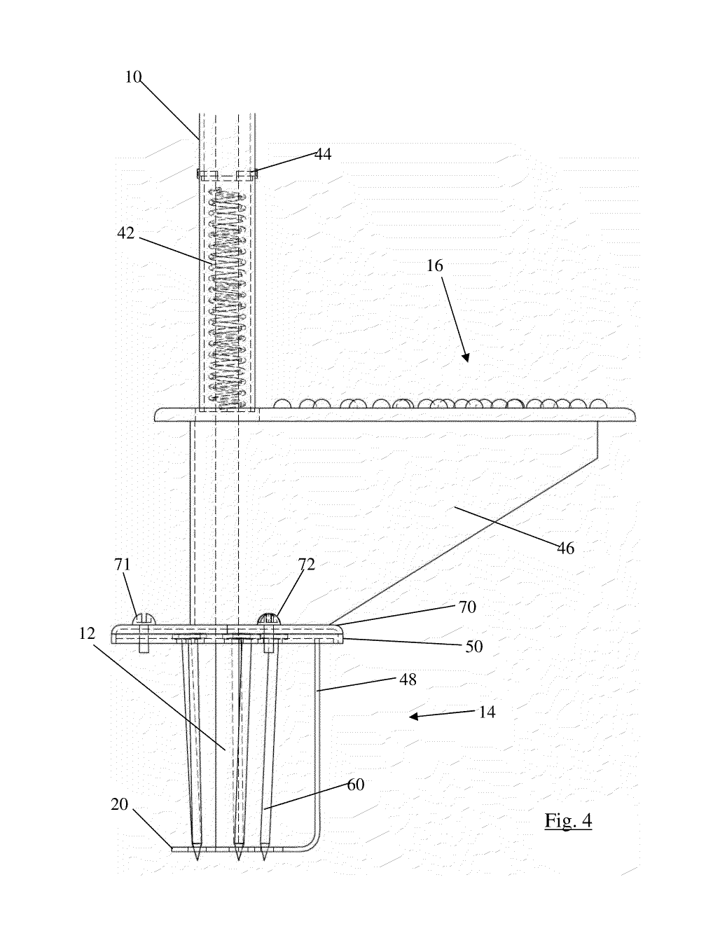

A central rod 12 extends slidably through the bore 11 and exits at the top through a narrow opening near a handle 18 as shown in FIGS. 2 and 3. The rod 12 exits at the bottom of the frame 10 through a narrow opening at the base portion 14 as shown in FIG. 4, and attaches to the disk 20 as described in more detail below. The terms “top”, “bottom”, “upper”, “lower” and similar terms are used in relation to the orientation of the device 8 as shown in FIG. 1. Of course, the device 8 can be used in different orientations than that shown in FIG. 1, and the person of ordinary skill will understand that the terms used herein transfer to the components in those different orientations.

As shown in FIGS. 2 and 3, a cap 13 fastens, such as by screwing onto a threaded tip (not visible) of the rod 12. The cap 13 permits a user to readily push and pull on the top end of the rod 12 as needed. Multiple substantially V-shaped indentations 30 are formed in one side of the rod 12 near the top end. Each of the indentations 30 can receive a distal end of a tab 32. The tab 32 is formed at the interior edge of a trigger 34 that is preferably spring-loaded toward the rod 12 by a bias, such as the coil spring 36. The coil spring 36 may be replaced, as will be understood by the person having ordinary skill, by a leaf spring, an elastomeric spring, a pneumatic spring, a magnetic spring or any other equivalent structure that tends to force the tab 32 toward the rod 12. The trigger 34 is mounted to the frame 10, such as through a bracket 38 welded to the opposite side of the frame 10 as the handle 18, to rotate relatively freely about the pivot 35, which is preferably a hinge. This configuration permits a person grasping the handle 18 to pivot the trigger 34 with one or more fingers toward or away from the rod 12.

The tab 32 can insert into the deepest or lowest region of one of the indentations 30 when the tab and the cooperating indentation 30 are aligned, or the tab 32 can rest against the surface of the rod 12 between the lowest regions of adjacent indentations 30. Regardless of whether the tab 32 and the lowest regions of an indentation are aligned, because of the angle of the tab 32 and the surfaces of the rod's indentations 30, the tab 32 preferably presents little to no resistance to upward movement of the rod 12 relative to the frame 10 (which can likewise be referred to as “downward movement of the frame 10 relative to the rod 12”). This is because the preferred embodiment forms a ratchet mechanism in which the indentations 30 are asymmetrical and define spaces between gear teeth and the tab 32 serves as a pawl. Thus, relative movement in one direction is not resisted significantly by the ratchet mechanism.

With regard to downward (opposite) movement of the rod 12 relative to the frame 10, when there is not alignment of the tab 32 with the lowest region of an indentation, the tab 32 is biased by the spring 36 against the surface of the rod 12 adjacent the lowest region of one of the indentations 30, and merely rests against the smooth surface. Under these conditions, the tab 32 does not resist downward movement of the rod 12. Downward movement of the rod 12 is permitted until the tab 32 is seated in the lowest region of an indentation 30. During normal use, upon insertion of the tab 32 into the lowest region of one of the indentations 30, the rod 12 is prevented from moving downward relative to the frame 10 until the tab 32 is removed from the indentation or the rod 12 is moved upwardly relative to the frame 10. Thus, when the tab 32 is in the lowest region of an indentation, the rod 12 cannot move downwardly relative to the frame 10, and when the tab 32 is not in the lowest region of an indentation, the rod 12 is able to move downwardly relative to the frame 10 until the lowest region is reached.

The coil spring 36 biases the tab 32 toward the rod 12, but the bias can be overcome by an average human grasping the trigger 34. The tab 32 may thus be pivoted away from the rod 12 by a finger-graspable portion of the trigger 34 that mounts below the handle 18 as shown in FIGS. 2 and 3. The finger-graspable portion of the trigger 34 is preferably grasped by an operator whose hand is around the handle 18, and whose finger or fingers extend beneath the trigger 34. The trigger 34 therefore can be displaced upwardly toward the handle 18 in the manner of a trigger of a typical firearm. When this occurs with sufficient force, the tab 32 withdraws from any indentation 30 in which the tab 32 is positioned, and the rod 12 is able to move downwardly relative to the frame 10.

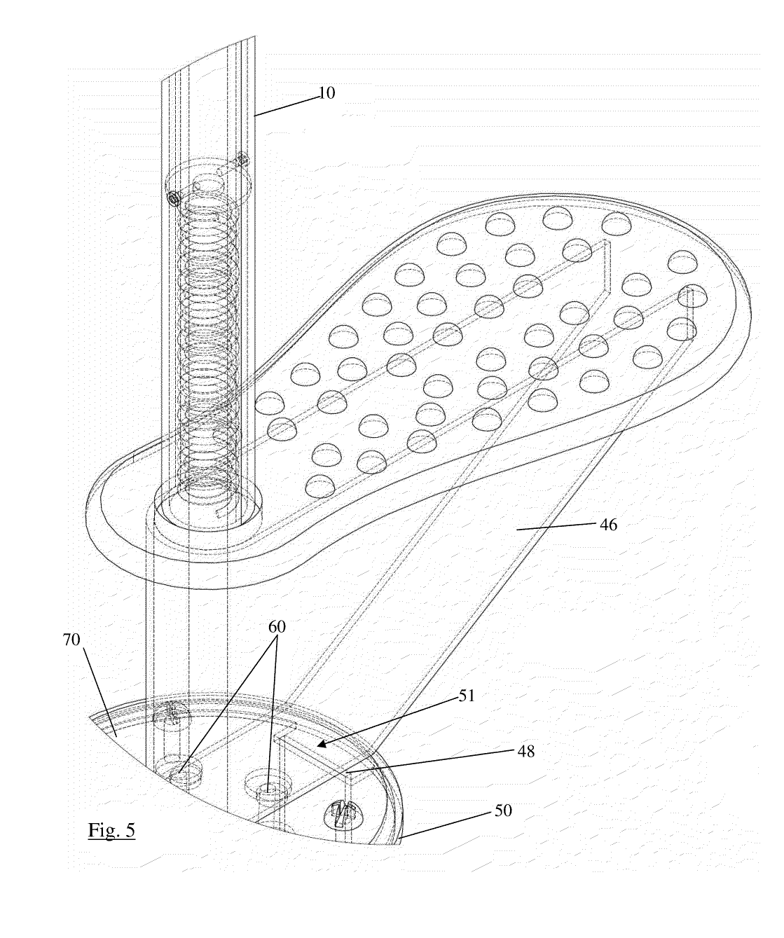

As shown in FIGS. 4-5, an upper end of the foot pedal 16 mounts rigidly to the lower end of the frame 10, such as by welding. The foot pedal 16 permits a user to press downwardly with substantial force on the device 8 with a foot on the top of the foot pedal 16. This downward force is typically applied when the base portion 14 rests on the soil around a weed.

As shown in FIGS. 1 and 4, a lower disk 20 that can be about two inches in diameter is rigidly mounted to the lower end of the rod 12, such as by welding. This disk 20 increases the effective surface area of the end of the rod 12 so that upon a user pressing the base portion 14 against the ground, such as when the frame 10 is perpendicular to the surface of the ground, the disk 20 and attached rod 12 do not substantially penetrate the soil, and thus stay at the same point on the ground while the frame 10 and its associated components are driven downwardly relative to the substantially stationary rod 12.

As shown in FIGS. 4-7, a coil spring 42 within the bore 11 of the frame 10 surrounds the lower end of the rod 12. The spring 42 can be a 12-15 pound, one-half inch outer diameter coil spring that is approximately four inches long when relaxed. Of course, other spring sizes, types and weights can be used under different circumstances.

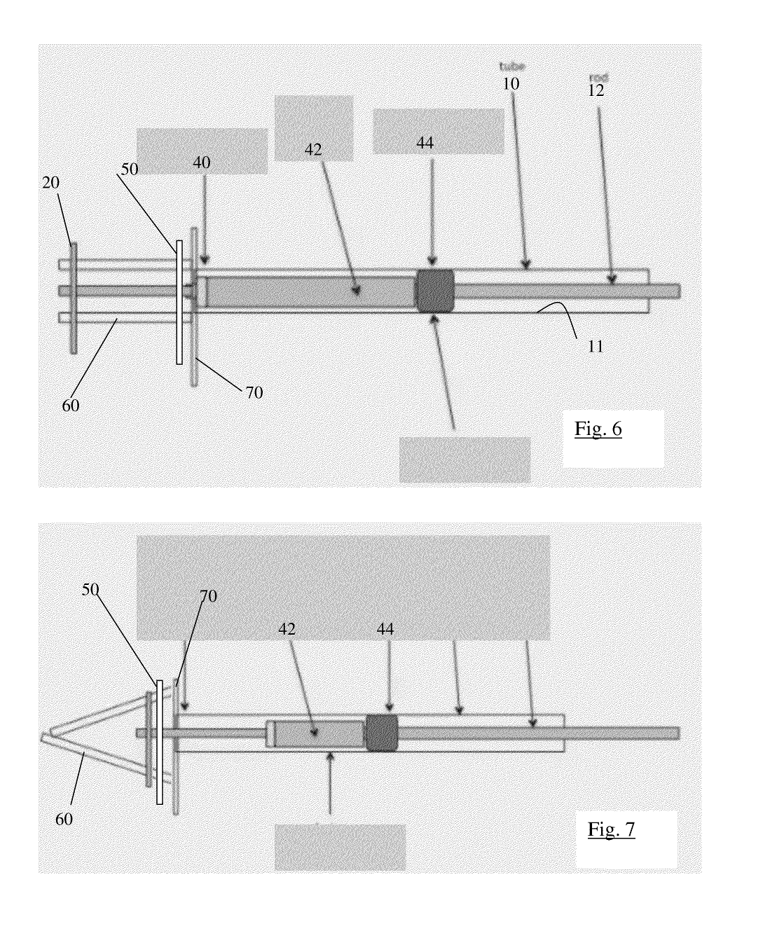

One end of the coil spring 42 seats against a pin 44 closer to the upper end of the rod 12, and the opposite end of the spring 42 seats against a ferrule 40 (see FIGS. 6-7) near the lower end of the rod 12. The pin 44 is rigidly mounted to the frame 10, and the rod 12 can bypass the pin 44. The rod 12 slidably extends through an opening between the two ends of the pin 44. The spring 42 cannot bypass the pin 44 but is compressed against the pin 44.

The ferrule 40 is rigidly mounted to the rod 12, and seats against the flange 70 when the coil spring 42 is expanded (see FIG. 6). As the rod 12 moves upwardly relative to the frame 10, the ferrule 40 moves upwardly away from the flange 70 with the rod 12 (see FIG. 7) and causes compression of the spring 42 between the ferrule 40 and the pin 44. The ferrule 40 provides an opposing surface against which the spring's 42 lower end abuts and a mechanical stop to prevent the rod 12 from traveling in the downward direction out of the frame 10 when the trigger releases the rod 12.

The preferred spring 42 provides a resistive force against movement of the rod 12 upwardly relative to the frame 10. Upon relative upward movement of the rod 12 by overcoming the spring force (typically caused by placing the operator's foot on the pedal 16), the spring 42 compresses to store potential energy. Upward movement of the rod 12 corresponds to compression of the spring 42 against the lower face of the pin 44, and downward movement of the rod 12 relative to the frame 10 corresponds to expansion of the spring 42. Because the pin 44 is rigidly affixed to the wall of the frame 10, the pin 44 provides a rigid base for the force of the spring 42 to push against to move the rod 12 downwardly relative to the frame 10 after the rod 12 is released when the spring 42 is compressed.

As shown in FIG. 4, a preferably L-shaped bracket 48 is rigidly attached to one side of the lower disk 20. The upper leg of the bracket 48 extends upwardly through a guide slot 51 (see FIG. 5), preferably formed at one end of the upper disk 50, and into a void formed between the sidewalls of the support 46 for the foot pedal 16. The bracket 48 is rigidly mounted to the lower disk 20 and is guided by the sidewalls of the support 46 and the slot 51 in the upper disk 50, which upper disk 50 is rigidly mounted to the frame 10. Because the bracket 48 is so retained, the rod 12 cannot rotate substantially, such as when the rod 12 is moving up or down relative to the frame 10.

The flange 70 (FIG. 4) is substantially the same diameter as the upper disk 50 and is rigidly mounted, such as by welding, to the lower end of the foot pedal 16. The flange 70 has a central opening through which the lower end of the rod 12 extends freely. The upper disk 50 is fastened to the flange 70 by screws 71 and 72. Multiple downwardly extending spikes 60 are spaced evenly around the rod 12 and are mounted with their heads pivotably mounted in spaces between the upper disk 50 and the flange 70. The shafts of the spikes 60 extend downwardly through spaced openings in the upper disk 50, and the pointed tips of the spikes 60 are at the opposite ends from the enlarged heads, extending through holes in the lower disk 20.

The rod 12 is free to travel through a central opening in the upper disk 50, and extends down to attachment to the lower disk 20, which has similarly spaced openings as the upper disk 50 that allow the spikes 60 to pass freely through the disk 20. The openings of the lower disk 20 are spaced slightly closer to the axis of the rod 12 than the openings of the upper disk 50. Thus, when the lower disk 20 moves upwardly with the rod 12 relative to the frame 10, the spikes 60 are guided by the sidewalls of the openings in the lower disk 20 to pivot inwardly until, when the disk 20 is as high as it can raise and the spring 42 is fully compressed, the tips of the spikes 60 are close to, or touching, one another. This movement inward is illustrated in FIG. 7, and causes the soil and the roots of a weed positioned between the spikes 60 to be grasped by the spikes 60.

The upper disk 50 and lower disk 20 are mounted directly below the flange 70, shown in FIGS. 4 and 5. Serrated tines (not shown) may be rigidly mounted around the flange 70 at evenly spaced intervals. The tines can attach to the flange 70 by screws, welds or any fastener. The tines increase the area to include the broad leaves that extend from the center of the plant as will be described below.

In use, the operator locates a weed in the soil, sand or other particulate found in a conventional yard and disposes the pointed tips of the spikes 60 against or close to the ground with the tips of the spikes 60 disposed around, and encircling, the main root of the weed. The frame 10 is oriented approximately vertically by disposing the handle 18 at about waist height, where the operator firmly grasps the handle 18. The operator places his or her foot on the top surface of the foot pedal 16, and begins to rest his or her body weight down on the foot pedal 16. This initial downward force displaces the entire device downwardly until the contacting surface (the lower disk 20) compresses any grass plants surrounding the weed. Upon continued downward force, the disk 20 seats against the upper surface of the ground, or more typically the compressed grass plants surrounding the weed, and with further force the frame 10 begins to move downwardly relative to the rod 12 and disk 20.

In order for the frame 10 to move downwardly relative to the rod 12 and disk 20, the downward force must exceed the force necessary to compress the spring 42. Once this occurs, the tips of the spikes 60 begin to extend downwardly through the disk 20. The spikes 60 enter the soil and are driven further downwardly (along with insertion of the tines, if any). At this time, the disk 20 stays in the same position relative to the top of the ground. Further pressure results in further compression of the spring 42 and further insertion of the spikes 60 and tines, if any.

As the spikes 60 move downwardly and the disk 20 remains stationary, the spikes 60 pivot inwardly as shown in the illustrations of FIG. 6 to FIG. 7. Simultaneous with the rod 12 being held stationary relative to the ground while the frame 10 moves downwardly, the spring 42 compresses as described above. While the frame 10 moves downwardly relative to the rod 12, the tab 32 slides without significant resistance over the indentations 30 on the side of the rod 12 facing away from the handle 18.

Once the spikes 60 have reached their full insertion into the soil and the spring 42 is fully compressed, the weed's root and some surrounding soil have been grasped by the spikes 60 as a soil “plug”. At this point the tab 32 seats in the lowest region of an indentation 30, or is between lowest regions of adjacent indentations. If the operator rotates the handle 18 approximately 90 degrees to permit any tines to form a cylindrical cut in the soil, this rotating action will free a larger “plug” consisting of soil and weed that might contain more roots and more leaves.

The operator then extracts the plug from the ground by lifting the device 8 vertically upwardly. When lifting the device 8, the operator's downward force is removed, which may cause the rod 12 to begin to move in the opposite direction as the compressed spring 42 begins to expand. The movement of the rod 12 relative to the upwardly moving frame 10 is arrested by the tab 32 being biased into the lowest region of the closest one of the indentations 30 in the rod 12 by the bias of the spring 36. Thus, the ratchet mechanism allows some, but then prevents further, relative movement of the rod 12 and frame 10. In this “locked” condition, the operator continues lifting the device 8 upwardly to completely remove the plug of soil containing the weed and no relative movement of the rod 12 occurs.

Whenever he or she chooses, but preferably when the device 8 is raised to between the weed and the operator, the operator squeezes the trigger 34 to release the plug and weed. Squeezing the trigger 34 lifts the tab 32 from the lowest region of the respective indentation 30, thereby freeing the rod 12 to move under the influence of the compressed spring 42 relative to the frame 10. Because the spring 42 is significantly compressed and has a high spring constant, the rod 12 moves rapidly relative to the frame 10 during spring expansion, thereby rapidly displacing the lower disk 20 away from the upper disk 50. This high speed movement causes the weed and soil plug to be ejected from the device 8 with sufficient force to allow the operator to expel the weed into a container, such as a trash can, brush container or compost container. This permits the operator to avoid bending over to obtain the plug and weed from the tip of the tool, or completely rotating the tool so the distal end is close to the user for removal. The device 8 instead serves as a “gun” that “shoots” the weed and plug out of the tool into a container or area that can be a few feet, and up to many feet, away.

The present invention has improved on the prior art's attempt to eject the weed. The present invention provides a significant enough force to propel the weed rather than merely release it. The weed is ejected with enough force to reach a container six to eight feet away, thereby eliminating the need to stoop or bend over to collect the weed, which the prior art requires. Furthermore, the mechanical “catch” formed where the tab 32 positively engages the rod 12 by inserting into the indentation is not subject to failure when the components thereof are wet, dirty or otherwise not encountering ideal conditions.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved weed extraction device having an elongated frame with a central bore through which a rod extends, a foot pedal rigidly mounted to the frame, a handle extending from the frame, and a plurality of pins that are drivingly linked to the rod and that extend away from the frame for inserting into soil surrounding a weed, the improvement comprising
(a) a spring that is drivingly linked to the rod and frame for compressing the spring when the rod is moved in a first direction relative to the frame;
(b) a lock that limits movement of the rod relative to the frame in a second, opposite direction; and
(c) a trigger mounted adjacent the handle and that is configured to unlock the lock upon movement thereof, thereby displacing the rod relative to the frame in the second direction under expansion of the compressed spring at speed sufficient to eject the weed from the device and project the weed a predetermined distance from the device.

2. The improved weed extraction device in accordance with claim 1, wherein the lock further comprises:
(a) a tab formed on the trigger;
(b) a bias mounted to the trigger to bias the tab toward the rod; and
(c) a plurality of indentations formed on the rod and into which the tab can insert for locking the rod against movement of the rod in the second direction.

3. The improved weed extraction device in accordance with claim 2, wherein the trigger is mounted beneath the handle when the device is in an operable orientation, the trigger pivots about a pivot point on an opposite side of the frame from the handle and the indentations on the rod are formed on a side of the rod facing away from the handle

4. The improved weed extraction device in accordance with claim 3, wherein the foot pedal mounts rigidly to an end of the frame and has a pair of spaced sidewalls forming a gap therebetween.

5. The improved weed extraction device in accordance with claim 4, further comprising an anti-rotation guide extending toward the frame from attachment to a lower disk, wherein the lower disk is mounted to the rod, and the guide extend into the gap between the sidewalls.

6. A method of using a weed extraction device having an elongated frame with a central bore through which a rod extends, a foot pedal rigidly mounted to the frame, a handle extending from the frame, and a plurality of pins that are drivingly linked to the rod and that extend away from the frame for inserting into soil surrounding a weed, the method comprising:
(a) depressing the frame at the foot pedal downwardly toward the soil surrounding the weed, thereby:
(i) moving the rod in a first direction relative to the frame;
(ii) compressing a spring that is drivingly linked to the rod and frame;
(iii) inserting the pins into the soil around the weed;
(iv) grasping the weed and at least some soil; and
(v) locking a lock that limits movement of the rod relative to the frame in a
(b) lifting the device by at least the handle, thereby removing at least the device and the weed from the soil;
(c) while grasping the handle, raising from the ground a lower end of the device that includes at least said plurality of pins;
(d) positioning the lower end of the device substantially between the user and a receptacle; and
(e) grasping a trigger mounted adjacent the handle to unlock the lock, thereby causing the rod to move relative to the frame in the second direction under expansion of the compressed spring at speed sufficient to eject the weed from the device and project the weed a predetermined distance from the device.
